(19) United States
(12) Patent Application Publication
(10) Pub. No.: US 2013/0052406 A1
(43) Pub. Date: Feb. 28, 2013

(54) COMPOSITE STRUCTURAL ELEMENT

(71) Applicant: Chin-Hui CHEN, Yang-Mei Cheng (TW)

(72) Inventor: Chin-Hui CHEN, Yang-Mei Cheng (TW)

(21) Appl. No.: 13/327,709

(22) Filed: Dec. 15, 2011

(30) Foreign Application Priority Data
Aug. 25, 2011 (TW) 100215912

(51) Int. Cl. B32B 3/26; B32B 3/10

(52) U.S. Cl. 428/119; 428/188; 428/161; 428/178

(57) ABSTRACT

A composite structural element is provided with a hollow spine member of metal or alloy, and a surrounding member of plastic material around the spine member. The spine member includes at least one lengthwise shaped member and at least one lengthwise rib. The structural element can accommodate thermal expansion or contraction to prevent itself from breaking.

### BACKGROUND OF THE INVENTION

1. Field of the Invention

The invention relates to composite materials and more particularly to a structural element of composite material having a hollow spine member of metal or alloy, and a surrounding member of plastic material so as to accommodate thermal expansion or contraction to prevent itself from breaking.

2. Description of Related Art

Typically, a pipe or bar of plastic material is low in strength. Also, a pipe or bar of metal tends to deform and/or get rusted. A structural element of composite material consisting of metal and plastic material has the advantages of being resistant to deformation, rust, and bending, improved structural strength, tensile strength, and flexual strength, and good touch feeling, without painting, and without maintenance due to the surrounding member of plastic material. Thus, it is widely used in the manufacture of industrial products.

One kind of composite material is of plastic material mixed with wood. The plastic material is from recycled plastic material and environmentally friendly. Products of such composite material are widely used as beams or columns in parks, kiosks, and trails due to its increased structural strength. However, it tends to break in the cooling step of manufacturing process. Also, sudden temperature change may cause such products to break.

A typical structural element (e.g., a pipe having a longitudinal section of circle) of composite material is shown in FIG. 1 and comprises a spine member A of metal and a surrounding member B of plastic material. The structural element tends to break when subjecting to sudden temperature drop or rise due to little tolerance for both the spine member A and the surrounding member B. Thus, the need for improvement still exists.

### SUMMARY OF THE INVENTION

It is therefore one object of the invention to provide a structural element of composite material comprising a hollow spine member; and a surrounding member formed around the spine member, wherein the spine member comprises at least one lengthwise shaped member.

The above and other objects, features and advantages of the invention will become apparent from the following detailed description taken with the accompanying drawings.

### BRIEF DESCRIPTION OF THE DRAWINGS

FIG. 1 is a perspective view of a conventional structural element implemented as a pipe;

FIG. 2 is a perspective view of a composite structural element according to the invention;

FIG. 3 is a fragmentary view of FIG. 2 with a portion of the surrounding member removed;

FIG. 4 is a longitudinal sectional view of FIG. 2 showing a first preferred embodiment of surrounding member and a first preferred embodiment of the spine member;

FIG. 5 is a view similar to FIG. 4 showing a second preferred embodiment of the spine member;

FIG. 6 is a view similar to FIG. 4 showing a third preferred embodiment of the spine member;

FIG. 7 is a view similar to FIG. 4 showing a second preferred embodiment of surrounding member and a fourth preferred embodiment of the spine member;

FIG. 8 is a view similar to FIG. 4 showing a third preferred embodiment of surrounding member and a fifth preferred embodiment of the spine member; and

FIG. 9 is a view similar to FIG. 4 showing a fourth preferred embodiment of surrounding member and a sixth preferred embodiment of the spine member.

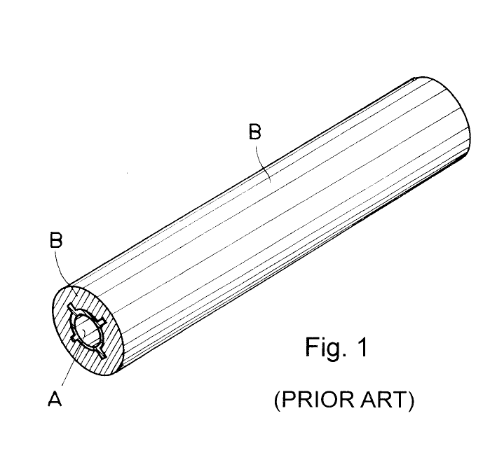

### DETAILED DESCRIPTION OF THE INVENTION

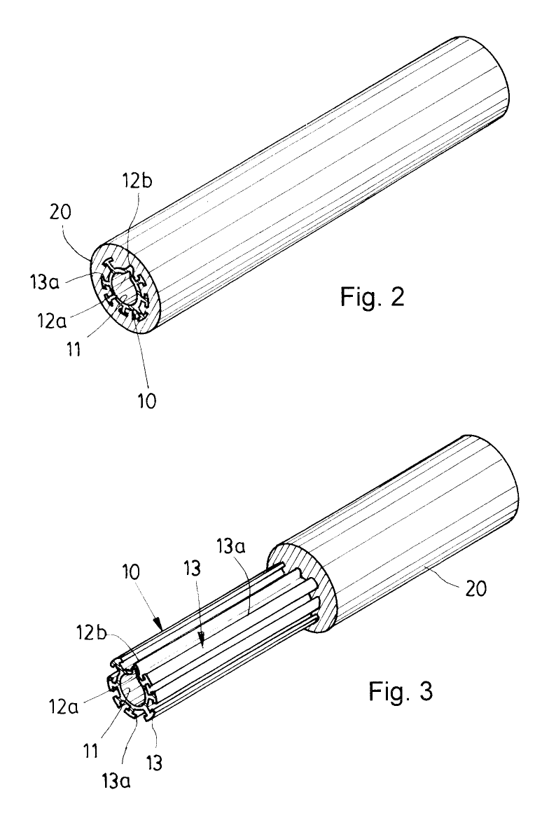

Referring to FIGS. 2 to 6, a structural element (e.g., in the form of a pipe) in accordance with the invention comprises a hollow spine member 10 and a surrounding member 20 formed around the spine member 10. Each component will be discussed in detail below.

The spine member 10 is of metal such as aluminum, aluminum alloy, steel, copper, zinc, or a combination thereof. The spine member 10 comprises a cylindrical member 11, at least one lengthwise groove member 12 formed on the cylindrical member 11, and a plurality of lengthwise ribs 13. The rib 13 has a transverse section 13a of a T when viewing from either end of the spine member 10. Such arrangements of the ribs 13 can increase contact areas of the ribs 13 and the surrounding member 20 so as to increase the structural strength of the structural element.

The surrounding member 20 is of thermoplastics (e.g., PE (polyethylene) or PP (polypropylene)) or a mixture of the thermoplastics and wood, glass fiber, etc. The thermoplastics or the mixture thereof turns to a liquid when heated and freezes to a very glassy state around the spine member 10 when cooled sufficiently.

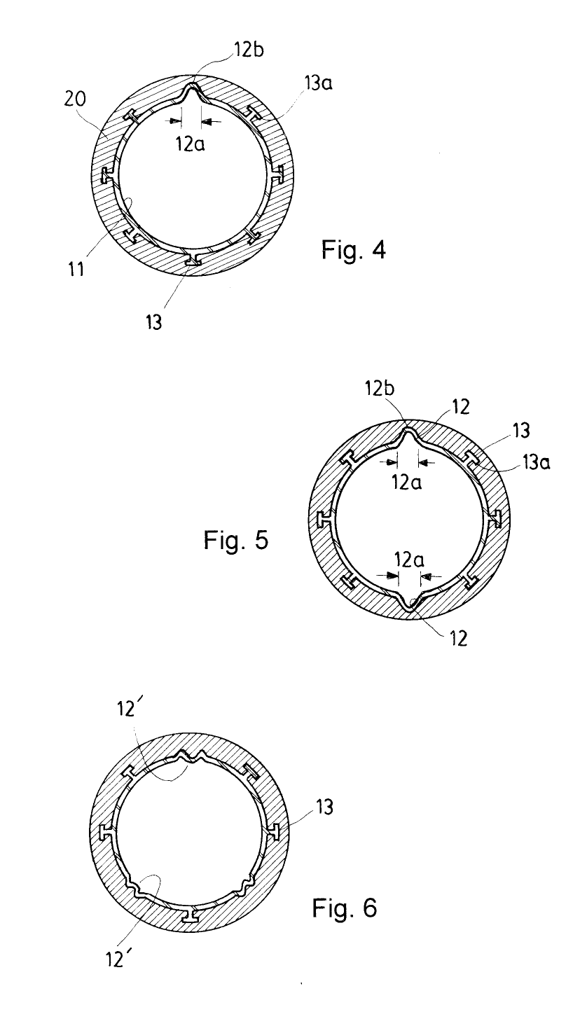

As shown in FIGS. 4 and 5, the groove member 12 comprises an opening 12a and a curved section 12b. The opening 12a may either expand to increase diameter of the spine member 10 due to, for example, temperature rise or contract to decrease diameter of the spine member 10 due to, for example, temperature drop.

Both the spine member 10 and the surrounding member 20 are in an expansion state prior to cooling in the manufacturing process. Both the spine member 10 and the surrounding member 20 are cooled in the final phase of the manufacturing process with different contraction coefficients. Advantageously, the groove member 12 of the cylindrical member 11 into the surrounding member 20 can provide a sufficient tolerance for accommodating space increase due to temperature rise or space decrease due to temperature drop of the structural element. As a result, the surrounding member 20 is prevented from breaking after leaving the factory.

As shown in FIGS. 2, 3 and 4, only one groove member is provided on the spine member 10. As shown in FIG. 5, two groove members 12 are provided on the spine member 10 and as shown in FIG. 6, two groove members 12′ are provided on the spine member 10 respectively. The groove member 12 may be shaped as a gable (see FIG. 5). Alternatively, the groove member 12′ is shaped as a series of two gables (see FIG. 6). Above both and other shapes are possible by the invention as long as they provide an expansion or contraction means to accommodate space variation (e.g., diameter variation of the spine member 10) due to ambient conditions (e.g., temperature) changes. As a result, the final products (e.g., the structural elements) are prevented from breaking.

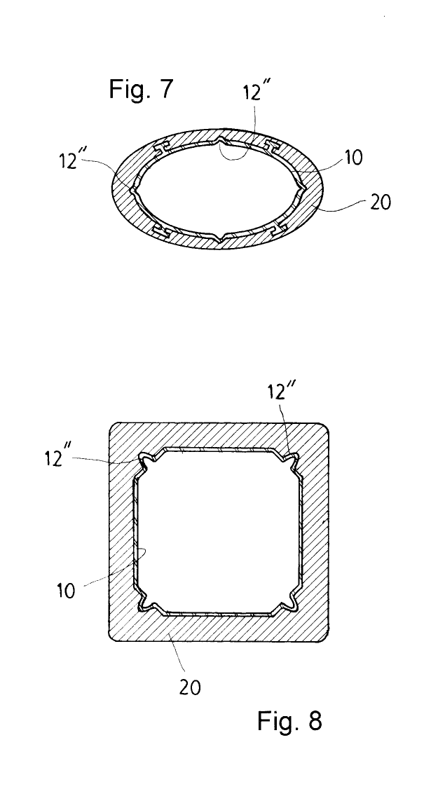

The structural elements have a longitudinal section of other than circle as also envisaged by the invention. For example, referring to FIG. 7, the structural element has an oval longitudinal section. Also, a plurality of equally spaced groove members 12″ are provided on the spine member 10. Further, referring to FIG. 8, the structural element has a square longitudinal section. Also, a plurality of equally spaced groove members 12″ are provided on four corners of the spine member 10. Both can provide an expansion or contraction means to accommodate space variation (e.g., diameter variation of the spine member 10) due to ambient conditions (e.g., temperature) changes. As a result, the final products (e.g., the structural elements) are prevented from breaking.

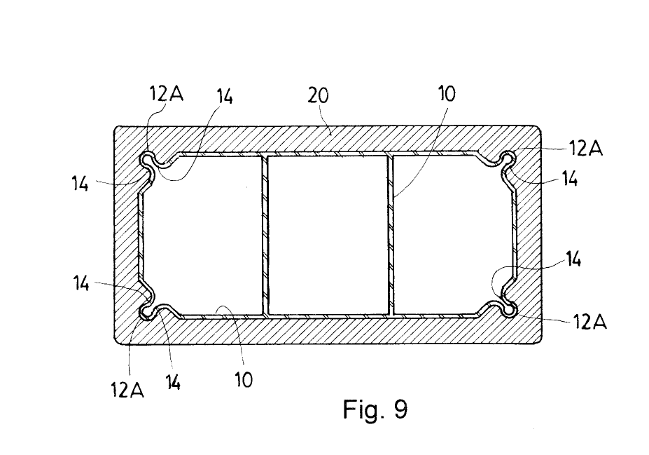

Referring to FIG. 9, the structural element has a rectangular longitudinal section. Internal space of the spine member 10 is divided into three parallel compartments. A shaped accommodation member 14 is provided on each of four corners of the spine member 10. Further, the accommodation member 14 has a projection 12A of curved longitudinal section. This embodiment has a further improved structural strength. Similarly, the embodiment can provide an expansion or contraction means to accommodate space variation (e.g., periphery variation of the spine member 10) due to ambient conditions (e.g., temperature) changes. As a result, the final products (e.g., the structural elements) are prevented from breaking.

It is noted that the groove members having a shape other than above are envisaged by the invention.

While above description is directed to a pipe, other final products such as bars, plates, etc. of the structural elements are envisaged by the invention.

While the invention has been described in terms of preferred embodiments, those skilled in the art will recognize that the invention can be practiced with modifications within the spirit and scope of the appended claims.

What is claimed is:

1. A structural element of composite material comprising:
a hollow spine member; and
a surrounding member formed around the spine member,
wherein the spine member comprises at least one lengthwise shaped member.

2. The structural element of composite material claim 1, wherein the spine member further comprises at least one lengthwise rib.

3. The structural element of composite material claim 2, wherein each of the at least one rib is shaped as a T.

4. The structural element of composite material claim 1, wherein the spine member is of aluminum, aluminum alloy, steel, copper, zinc, or a combination thereof.

5. The structural element of composite material claim 1, wherein each of the at least one shaped member has a longitudinal section of curve, gable, or a series of gables.

6. The structural element of composite material claim 1, wherein the spine member has a longitudinal section other than a circle.

7. The structural element of composite material claim 1, wherein the spine member comprises a plurality of accommodation member each having a projection of curved longitudinal section.
